(19) United States
(12) Patent Application Publication
(10) Pub. No.: US 2020/0117852 A1
(43) Pub. Date: Apr. 16, 2020

(54) METHOD FOR TRACKING IN OFFICE FILE CONVERSION AND MODIFICATION PROCESSES

(71) Applicant: FUJIAN FOXIT SOFTWARE DEVELOPMENT JOINT STOCK CO., LTD., Fuzhou, Fujian (CN)

(72) Inventor: Fangming Liu, Beijing (CN)

(21) Appl. No.: 16/305,604

(22) PCT Filed: Apr. 25, 2017
(86) PCT No.: PCT/CN2017/000320

§ 371 Date: Nov. 29, 2018

(30) Foreign Application Priority Data
Jun. 15, 2016 (CN) 201610422318.8

(51) Int. Cl. G06F 40/197; G06F 40/103; G06F 40/14

(52) U.S. Cl. CPC G06F 40/197; G06F 40/14; G06F 40/103

(57) ABSTRACT

A method for tracking in Office file conversion and modification processes, including the following steps: S1: generating a piece of customized data containing a unique ID; S2: when an Office file is being generated or is generated, using a custom XML mechanism for Office files to save the customized data in the XML format into the Office file; S3: keeping the unique ID unchanged when the Office file is modified; S4: when the Office file is converted into a target file of a target format, if the target format supports the saving of the customized data, then transferring the customized data into the target file, thus allowing a user to manage the target file on the basis of the customized data; S5: when the Office file acquired in step S2 is updated and a new Office file is generated again, keeping the unique ID unchanged in the new Office file.

### FIELD OF THE INVENTION

The present invention relate to a technical field of document management, and particularly to a method for tracking in a process of converting and modifying an Office document.

### BACKGROUND OF THE INVENTION

An Office document can be converted from an original document in other formats (such as PNG, PDF, HTML, etc.) by various computer software. This conversion process involves re-expressing a content of the original document. In addition to a change in the expression form of information, the content of the original document may change more or less at the same time. Usually, the Office document generated by conversion is an independent entity and has no direct relationship with the original data. After the generated Office document is converted, a target document is newly generated, and the target document has a similar appearance to the original document, but has a certain difference from the original document in content and expression form, thus a further use and a further modification of the user may gradually expand this difference between the newly generated target document and the original document. In order to enable the user to recognize the source document in the subsequent use process, the user can manually record a homologous relationship between the original document and the Office documents, that is, both of them are modified or converted from the same source document. However, in many scenarios, manual recording is very inconvenient and even more difficult.

Therefore, it is a problem urgently to be solved by those skilled in the art about how to divide a large number of documents into homologous document clusters according to the homologous relationship in managing a large number of documents, thereby providing convenience for system data statistics and user information search.

### SUMMARY OF THE INVENTION

The present invention provides a method for tracking in a process of converting and modifying an Office document, which is used to divide a large number of documents into homologous document clusters according to the homologous relationship in managing a large number of documents, thereby providing convenience for system data statistics and user information search.

To achieve the above object, the present invention provides a method for tracking in a process of converting and modifying an Office document, comprising the following steps:

S1: Generating customized data containing a unique ID;

S2: When an Office document is being generated or is generated, using a custom XML mechanism for the Office document to save the customized data in an XML format into the Office document;

S3: Keeping the unique ID unchanged when the Office document is modified;

S4: When the Office document is converted into a target document in a target format, if the target format is capable to support saving the customized data, then transferring the customized data into the target document, and a user is capable to manage the target document according to the customized data;

S5: When the Office document generated in the step S2 is updated and a new Office document is re-generated, keeping the unique ID unchanged in the new Office document.

In one embodiment of the present invention, the customized data is saved in a title or a note of the Office document metadata.

In one embodiment of the present invention, the customized data is saved in a hidden text of the Office document's body text.

The method for tracking in a process of converting and modifying an Office document provided by the present invention can automatically track a process of converting and modifying a generated Office document without manual intervention of the user. After the present invention is used, for two specific Office documents, it can be judged whether the Office documents are modified or converted from the same source document, and for documents in other formats obtained by reconversion of these Office documents, the above-mentioned judgment can be performed as well in the case where the target format can support the operations mentioned in the present invention. Therefore, the present invention can provide convenience for system data statistics and user information search, and has strong practicability.

### BRIEF DESCRIPTION OF THE DRAWINGS

In order to more clearly explain the embodiments of the present invention or the technical solution in the prior art, the embodiments or drawings required in the description of the prior art will be briefly introduced below. Obviously, the drawings in the description below are only some embodiments of the present invention. Those ordinary skilled in the art may also obtain other drawings without contributing creative labor.

FIG. 1 is a flow chart illustrating a method for tracking in a process of converting and modifying an Office document provided by the present invention.

### DETAILED DESCRIPTION OF THE EMBODIMENTS

The technical solution in the embodiment of the present invention will be described clearly and completely below in combination with the drawings in the embodiments of the present invention. Obviously, the described embodiments are only a part of embodiments of the present invention, but not all of the embodiments. Based on the embodiments of the present invention, all other embodiments obtained by those ordinary skilled in the art without contributing creative labor belong to the protection scope of the present invention.

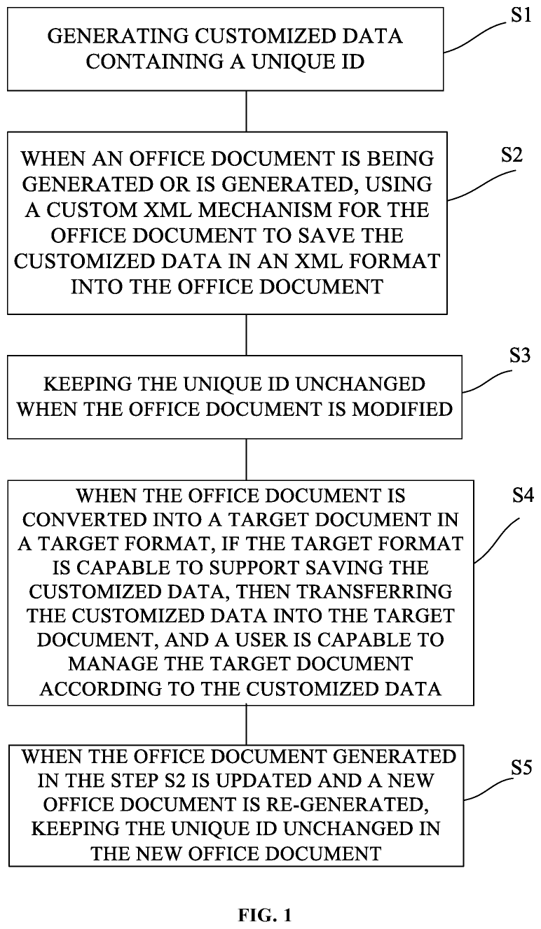

FIG. 1 is a flow chart showing a method for tracking in a process of converting and modifying an Office document provided by the present invention, as shown in the FIG. 1, the method for tracking in a process of converting and modifying an Office document provided by the present invention comprising the following steps:

S1: Generating customized data containing a unique ID;

S2: When an Office document is being generated or is generated, using a custom XML mechanism for the Office document to save the customized data in an XML format into the Office document;

S3: Keeping the unique ID unchanged when the Office document is modified;

S4: When the Office document is converted into a target document in a target format, if the target format is capable to support saving the customized data, then transferring the customized data into the target document, and a user is capable to manage the target document according to the customized data;

S5: When the Office document generated in the step S2 is updated and a new Office document is re-generated, keeping the unique ID unchanged in the new Office document.

In one embodiment of the present invention, the customized data may be saved in a title or a note of the Office document metadata.

In another embodiment of the present invention, the customized data may be saved in a hidden text of the Office document's body text.

Using the method for tracking in a process of converting and modifying an Office document. to judge two documents (document 1, document 2) and documents that may be converted from them are homologous documents includes the following steps:

(1) If the document 1 is an Office document, acquiring customized data containing a unique ID in the XML format from a custom XML mechanism of the Office document; and for a document in other format that may be generated by conversion of the document 1, trying to acquire the customized data in a mode corresponding to the target format;

(2) Performing the above-mentioned operation on the document 2 as well; and

(3) If these customized data have the same unique ID, indicating that they are homologous; if these customized data have different unique IDs, indicating that they are not homologous; and if the customized data are not obtained, indicating that these documents are not within the scope of discrimination of the present invention.

The method for tracking in a process of converting and modifying an Office document provided by the present invention can automatically track a process of converting and modifying a generated Office document without manual intervention of the user. After the present invention is used, for two specific Office documents, it can be judged whether the Office documents are modified or converted from the same source document, and for documents in other formats obtained by a reconversion of these Office documents, the above-mentioned judgment can be performed as well in the case where the target format is capable to support the operations mentioned in the present invention. Therefore, the present invention can provide convenience for system data statistics and user information search, and has strong practicability.

It will be appreciated by those ordinary skilled in the art that the drawings is only a schematic diagram of one embodiment, and the modules or processes in the drawings are not necessarily necessary for the implementation of the present invention.

It will be appreciated by those ordinary skilled in the art that the modules in the device of the embodiment may be distributed in a device of the embodiments according to the description of the embodiment, or may be located in one or more devices different from that of the present embodiment by making corresponding amendments. The modules of the above embodiment may be combined into one module or may be further split into multiple sub-modules.

Finally, it should be noted that: the above embodiments are only used for illustrating the technical solution of the present invention, but are not used for limiting the technical solution of the present invention. Although the present invention is described in detail with reference to the foregoing embodiments, it will be understood by those skilled in the art that modifications may be made to the technical solutions described in the foregoing embodiments, or equivalent replacements may be made to some of the technical features thereof. And these modifications or replacements do not make the essence of corresponding technical solutions depart from a spirit and a scope of the technical solution of the embodiments of the present invention.

1. A method for tracking in a process of converting and modifying an Office document, wherein, the method comprises the following steps:
S1: Generating customized data containing a unique ID;
S2: When an Office document is being generated or is generated, using a custom XML mechanism for the Office document to save the customized data in an XML format into the Office document;
S3: Keeping the unique ID unchanged when the Office document is modified;
S4: When the Office document is converted into a target document in a target format, if the target format is capable to support saving the customized data, then transferring the customized data into the target document, and a user is capable to manage the target document according to the customized data;
S5: When the Office document generated in the step S2 is updated and a new Office document is re-generated, keeping the unique ID unchanged in the new Office document.

2. The method for tracking in a process of converting and modifying an Office document according to claim 1, wherein, the customized data is saved in a title or a note of the Office document metadata.

3. The method for tracking in a process of converting and modifying an Office document according to claim 1, wherein, the customized data is saved in a hidden text of the Office document's body text.
